(19) United States
(12) Patent Application Publication
(10) Pub. No.: US 2014/0279677 A1
(43) Pub. Date: Sep. 18, 2014

(54) ONTOLOGY-DRIVEN CONSTRUCTION OF SEMANTIC BUSINESS INTELLIGENCE MODELS

(71) Applicant: INTERNATIONAL BUSINESS MACHINES CORPORATION, Armonk, NY (US)

(72) Inventors: Robin N. Grosset, Ottawa (CA); Mohsen M. Rais-Ghasem, Ottawa (CA)

(73) Assignee: International Business Machines Corporation, Armonk, NY (US)

(21) Appl. No.: 13/844,612

(22) Filed: Mar. 15, 2013

(51) Int. Cl. G06Q 10/06

(52) U.S. Cl. CPC G06Q 10/067
USPC 705/348

(57) ABSTRACT

Techniques are described for modeling information from a data source. In one example, a method for modeling information from a data source includes identifying one or more lexical clues associated with each of one or more data item headings from the data source based on a set of lexical clue detection rules. The method further includes mapping each of one or more of the data item headings to one or more business concepts based on comparing the one or more identified lexical clues associated with each of one or more of the data item headings with a business ontology that comprises a description of the business concepts. The method further includes generating a semantic business intelligence model comprising one or more semantic associations between the one or more data item headings based on the mapping of the data item headings to the one or more of the business concepts.

### TECHNICAL FIELD

The invention relates to business intelligence systems, and more particularly, to data models for business intelligence systems.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher level areas of responsibility in the organization. Moreover, once data has been entered, it must be retrieved to be utilized. The system may perform mathematical calculations on the data, combining data submitted by many users. Using the results of these calculations, the system may generate reports for review by higher management. Often these complex systems make use of multidimensional data sources that organize and manipulate the tremendous volume of data using data structures referred to as data cubes. Each data cube, for example, includes a plurality of hierarchical dimensions having levels and members for storing the multidimensional data.

Business intelligence (BI) systems may be used to provide insights into such collections of enterprise data. At the heart of a BI system may typically be a conceptual model that represents the business interpretation or business meaning of the enterprise data. Navigation or analysis of the enterprise data is ultimately grounded in such a conceptual model. Constructing such a conceptual model may typically require explicit intervention and manual data modeling by an expert data modeler. A BI system may use such a manually created data model to organize and describe large bodies of enterprise data to support useful business intelligence tools. A data model may contain descriptions of the structure and context of the data, and support queries of the data with the BI system. The data model may contain descriptions of the structure and nature of the data, such as portions of the data that are categories and portions of the data that are numeric metrics, for example. Such descriptions of the data may provide enough context to the BI system to allow it to create useful queries. BI systems also now may typically incorporate data from various unmodeled collections of data, such as spreadsheets and comma-separated values (CSV) files.

### SUMMARY

In general, examples disclosed herein are directed to techniques for constructing a semantic business intelligence data model from a data source.

In one example, a method includes identifying, with one or more computing devices, one or more lexical clues associated with each of one or more data item headings from the data source based on a set of lexical clue detection rules. The method further includes mapping, with the one or more computing devices, each of one or more of the data item headings to one or more business concepts based on comparing the one or more identified lexical clues associated with each of one or more of the data item headings with a business ontology that comprises a description of the business concepts. The method further includes generating, with the one or more computing devices, a semantic business intelligence model comprising one or more semantic associations between the one or more data item headings based on the mapping of the data item headings to the one or more of the business concepts.

In another example, a computer system for modeling information from a data source includes one or more processors, one or more computer-readable memories, and one or more computer-readable, tangible storage devices. The computer system further includes program instructions, stored on at least one of the one or more storage devices for execution by at least one of the one or more processors via at least one of the one or more memories, to identify one or more lexical clues associated with each of one or more data item headings from the data source based on a set of lexical clue detection rules. The computer system further includes program instructions, stored on at least one of the one or more storage devices for execution by at least one of the one or more processors via at least one of the one or more memories, to map each of one or more of the data item headings to one or more business concepts based on comparing the one or more identified lexical clues associated with each of one or more of the data item headings with a business ontology that comprises a description of the business concepts. The computer system further includes program instructions, stored on at least one of the one or more storage devices for execution by at least one of the one or more processors via at least one of the one or more memories, to generate a semantic business intelligence model comprising one or more semantic associations between the one or more data item headings based on the mapping of the data item headings to the one or more of the business concepts.

In another example, a computer program product for modeling information from a data source includes a computer-readable storage medium having program code embodied therewith. The program code is executable by a computing device to identify one or more lexical clues associated with each of one or more data item headings from the data source based on a set of lexical clue detection rules. The program code is further executable by a computing device to map each of one or more of the data item headings to one or more business concepts based on comparing the one or more identified lexical clues associated with each of one or more of the data item headings with a business ontology that comprises a description of the business concepts. The program code is further executable by a computing device to generate a semantic business intelligence model comprising one or more semantic associations between the one or more data item headings based on the mapping of the data item headings to the one or more of the business concepts.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example enterprise having a computing environment in which users interact with an enterprise business intelligence system and data sources accessible over a public network.

FIG. 2 is a block diagram illustrating one embodiment of an enterprise business intelligence computing environment including a semantic model constructor as part of a BI computing system.

FIG. 3 depicts a block chart of an overall architecture of a semantic model constructor in an operating context for modeling enterprise data in a business intelligence (BI) system.

FIG. 4 depicts details of an example semantic business intelligence model that a semantic model constructor may generate based on a dataset.

FIG. 5 depicts a process for semantic modeling of enterprise data that may be performed by a semantic model constructor in a business intelligence (BI) system.

FIG. 6 is a block diagram of a computing device that may execute a semantic model constructor as part of a BI computing system.

### DETAILED DESCRIPTION

Various examples are disclosed herein for a semantic model constructor in a business intelligence system for automatic semantic modeling of a data source. In various examples, a semantic model constructor may automatically provide semantic modeling of a data source by using detection rules and clues and applying concepts from a business ontology to data item headings and data items in the data source, thereby generating associations among categories of data, and mappings between the categories of data, as part of constructing a semantic model of the data. The semantic model of the data may be used to generate data visualizations that provide end users with high-level analysis and insight into the data.

FIG. 1 illustrates an example context in which a system of this disclosure may be used. FIG. 1 is a block diagram illustrating an example enterprise 4 having a computing environment 10 in which a plurality of users 12A-12N (collectively, “users 12”) may interact with an enterprise business intelligence (BI) system 14. In the system shown in FIG. 1, enterprise business intelligence system 14 is communicatively coupled to a number of client computing devices 16A-16N (collectively, “client computing devices 16” or “computing devices 16”) by an enterprise network 18. Users 12 interact with their respective computing devices to access enterprise business intelligence system 14. Users 12, computing devices 16A-16N, enterprise network 18, and enterprise business intelligence system 14 may all be either in a single facility or widely dispersed in two or more separate locations anywhere in the world, in different examples.

For exemplary purposes, various examples of the techniques of this disclosure may be readily applied to various software systems, including enterprise business intelligence systems or other large-scale enterprise software systems. Examples of enterprise software systems include enterprise financial or budget planning systems, order management systems, inventory management systems, sales force management systems, business intelligence tools, enterprise reporting tools, project and resource management systems, and other enterprise software systems.

In this example, enterprise BI system 14 includes servers that run BI dashboard web applications and may provide business analytics software. A user 12 may use a BI portal on a client computing device 16 to view and manipulate information such as business intelligence reports (“BI reports”) and other collections and visualizations of data via their respective computing devices 16. This may include data from any of a wide variety of sources, including from multidimensional data structures and relational databases within enterprise 4, as well as data from a variety of external sources that may be accessible over public network 15.

Users 12 may use a variety of different types of computing devices 16 to interact with enterprise business intelligence system 14 and access data visualization tools and other resources via enterprise network 18. For example, an enterprise user 12 may interact with enterprise business intelligence system 14 and run a business intelligence (BI) portal (e.g., a business intelligence dashboard, etc.) using a laptop computer, a desktop computer, or the like, which may run a web browser. Alternatively, an enterprise user may use a smartphone, tablet computer, or similar device, running a business intelligence dashboard in either a web browser or a dedicated mobile application for interacting with enterprise business intelligence system 14.

Enterprise network 18 and public network 15 may represent any communication network, and may include a packet-based digital network such as a private enterprise intranet or a public network like the Internet. In this manner, computing environment 10 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

FIG. 2 is a block diagram illustrating in further detail portions of one embodiment of an enterprise business intelligence (BI) system 14. In this example implementation, a single client computing device 16A is shown for purposes of example and includes a BI portal 24 and one or more client-side enterprise software applications 26 that may utilize and manipulate multidimensional data, including to view data visualizations and analytical tools with BI portal 24. BI portal 24 may be rendered within a general web browser application, within a locally hosted application or mobile application, or other user interface. BI portal 24 may be generated or rendered using any combination of application software and data local to the computing device it's being generated on, and/or remotely hosted in one or more application servers or other remote resources.

BI portal 24 may output data visualizations for a user to view and manipulate in accordance with various techniques described in further detail below. BI portal 24 may present data in the form of charts or graphs that a user may manipulate, for example. BI portal 24 may present visualizations of data based on data from sources such as a BI report, e.g., that may be generated with enterprise business intelligence system 14, or another BI dashboard, as well as other types of data sourced from external resources through public network 15. BI portal 24 may present visualizations of data based on data that may be sourced from within or external to the enterprise.

FIG. 2 depicts additional detail for enterprise business intelligence system 14 and how it may be accessed via interaction with a BI portal 24 for depicting and providing visualizations of business data. BI portal 24 may provide visualizations of data that represents, provides data from, or links to any of a variety of types of resource, such as a BI report, a software application, a database, a spreadsheet, a data structure, a flat file, Extensible Markup Language (“XML”) data, a comma separated values (CSV) file, a data stream, unorganized text or data, or other type of file or resource. BI portal 24 may also provide visualizations of data based on semantic data modeling information generated by a semantic model constructor 22. Semantic model constructor 22 may be hosted among enterprise applications 25, as in the example depicted in FIG. 2, or may be hosted elsewhere, including on a client computing device 16A, or distributed among various computing resources in enterprise business intelligence system 14, in some examples. Semantic model constructor 22 may be implemented as or take the form of a stand-alone application, a portion or add-on of a larger application, a library of application code, a collection of multiple applications and/or portions of applications, or other forms, and may be executed by any one or more servers, client computing devices, processors or processing units, or other types of computing devices.

As depicted in FIG. 2, enterprise business intelligence system 14 is implemented in accordance with a three-tier architecture: (1) one or more web servers 14A that provide web applications 23 with user interface functions, including a server-side BI portal application 21; (2) one or more application servers 14B that provide an operating environment for enterprise software applications 25 and a data access service 20; and (3) database servers 14C that provide one or more data sources 38A, 38B, . . . , 38N (“data sources 38”). Enterprise software applications 25 may include concept identifier tool 22 as one of enterprise software applications 25 or as a portion or portions of one or more of enterprise software applications 25. The data sources 38 may include two-dimensional databases and/or multidimensional databases or data cubes. The data sources may be implemented using a variety of vendor platforms, and may be distributed throughout the enterprise. As one example, the data sources 38 may be multidimensional databases configured for Online Analytical Processing (OLAP). As another example, the data sources 38 may be multidimensional databases configured to receive and execute Multidimensional Expression (MDX) queries of some arbitrary level of complexity. As yet another example, the data sources 38 may be two-dimensional relational databases configured to receive and execute SQL queries, also with an arbitrary level of complexity.

Multidimensional data structures are “multidimensional” in that each multidimensional data element is defined by a plurality of different object types, where each object is associated with a different dimension. The enterprise applications 26 on client computing device 16A may issue business queries to enterprise business intelligence system 14 to build reports. Enterprise business intelligence system 14 includes a data access service 20 that provides a logical interface to the data sources 38. Client computing device 16A may transmit query requests through enterprise network 18 to data access service 20. Data access service 20 may, for example, execute on the application servers intermediate to the enterprise software applications 25 and the underlying data sources in database servers 14C. Data access service 20 retrieves a query result set from the underlying data sources, in accordance with query specifications. Data access service 20 may intercept or receive queries, e.g., by way of an API presented to enterprise applications 26. Data access service 20 may then return this result set to enterprise applications 26 as BI reports, other BI objects, and/or other sources of data that are made accessible to BI portal 24 on client computing device 16A. These may include concept semantic enterprise data modeling information generated by semantic model constructor 22.

Semantic model constructor 22 may provide data modeling for any one or more of a multidimensional data structure or data cube, a database, a spreadsheet, a CSV file, an RSS feed, or other data source. Semantic model constructor 22 may provide automatic data modeling of a data source by analyzing data item headings and other data from the data source with reference to both a business ontology and a set of detection rules, and thereby map the data to higher-level meanings in the context of the applicable business or other enterprise. Data item headings may be column headings, row headings, sheet names, graph captions, file names, document titles, or other forms of headings for lists, categories, time-ordered variables, or other forms of data items from a data source, for example. Semantic model constructor 22 may also use the matching of data item headings to concepts in automatically generating data visualizations appropriate to the data associated with the data item headings, such as trend analysis graphs for time-ordered data or charts organized by entity names, for example, as further described below.

A business intelligence system comprising semantic model constructor 22 may provide insights into a user's data that may be more targeted and more useful, and may automatically describe the nature of the data based on a business ontology and a set of detection rules, rather than requiring manual data modeling. For example, a BI system incorporating semantic model constructor 22 may identify that a set of data from a data source pertains to how one or more values vary over time, and the BI system may output the set of data in an interface mode that is ordered by time, such as a trend analysis graph or a calendar, for example. A BI system incorporating semantic model constructor 22 may also model data from unmodeled sources, such as spreadsheets, CSV files, or RSS feeds, and data in multiple languages.

Semantic model constructor 22 may therefore provide more intelligent modeling and organization of enterprise data. This may include semantic model constructor 22 identifying data item headings with concepts defining what the data is related to, from data in either a modeled data source or an unmodeled data source (e.g., a spreadsheet or CSV file). For example, semantic model constructor 22 may identify a data item heading, such as the title of a column in a spreadsheet, as being associated with a particular concept of time. Semantic model constructor 22 may output this identification of the data item heading with this particular concept as part of a semantic data model to a consuming application or system, such as a BI dashboard or other type of BI portal, which may use this identification to extrapolate that it can generate a time-based data visualization, such as a trend analysis graph, with the data from the data source.

Semantic model constructor 22 may make use of a business ontology that may include externalized business ontologies describing business concepts in multiple languages, for example. Semantic model constructor 22 may make use of such a business ontology as well as a set of detection rules to automatically model information from a data source. Semantic model constructor 22 may provide a heuristic approach that may often correctly model and describe a dataset for a consuming BI application. Semantic model constructor 22 may thereby provide insight into the data without the need for manual data modeling, and quickly provide targeted insights into the data. That is, semantic model constructor 22 may constructing a conceptual model that represents the business interpretation or business meaning of a data set or data source without requiring explicit intervention and manual data modeling by an expert data modeler. One example of such modeling may be identifying and grouping related data items and assigning them specific roles.

For example, a data set may include AirportName and AirportCode as two data item headings that may be related, and AirportName may be used as a caption, while AirportCode may be used as an identifier. Another example may involve identifying data items that hold whole-part associations among them, such as State and City. Semantic model constructor 22 may eliminate or significantly reduce the need for manual data modeling by automatically construct such a business model. Semantic model constructor 22 may construct a semantic business model from a variety of data sources, from fully structured enterprise data sources to semi-structured sources such as a spreadsheet or CSV file. Semantic model constructor 22 may make use of an externalized business ontology that may include common and business-specific concepts such as time (e.g., year, quarter), geography (e.g., city, country) product, revenue, and so on.

Semantic model constructor 22 may primarily use lexical clues and various data hints to create a mapping between the data items in a data source and various business concepts. Semantic model constructor 22 may ultimately build a semantic business model based on such mappings between data items and business concepts. Such a semantic business model created by semantic model constructor 22 may then be used to offer insightful analyses, such as in a BI dashboard or any type of BI portal, BI user interface, and/or BI data visualization. For example, given a set of data items representing product, revenue, and time, semantic model constructor 22 may automatically construct a semantic model that enables a BI system to automatically generate analyses to chart product revenue trend over time or to compare product revenues for a particular period of time, as illustrative examples.

FIG. 3 shows a high level overview of an example process performed by semantic model constructor 22. Central to the system is a business ontology with concepts representing both the common knowledge and specific business knowledge. As one example, through this business ontology, semantic model constructor 22 may retain a conceptual model indicating that businesses often organize product offerings in categories (e.g., product lines, brands, and individual items). As another example, through this business ontology, semantic model constructor 22 may retain a conceptual model indicating that a sales order may typically include one or more sales items, a base price for each of the one or more sales items, potentially a discount on the base price, and a client that has placed the sales order, among other things.

Semantic model constructor 22 may use another source of information that includes a system of rules and clues to detect business concepts and scenarios. This system of rules and clues may generally be organized into two categories, lexical (such as label) and value-based (such as data patterns or exemplar values). Lexical clues, by their nature, may be ambiguous and semantic model constructor 22 may manage such ambiguities by various means including contextual clues.

As an example of using contextual clues to disambiguate lexical clues, semantic model constructor 22 may encounter a data item heading that consists of or includes the word “volume,” the meaning of which may be ambiguous in isolation. Semantic model constructor 22 may evaluate potential contextual clues in content surrounding the data item heading consisting of or including the term “volume.” The surrounding content, such as other, horizontally or vertically proximate (described below) data item headings, may contain other terms that serve as contextual clues related either to stock market trading, or to cargo delivery, for example. If semantic model constructor 22 discovers contextual clues related to stock market trading, semantic model constructor 22 may then determine that the data item heading “volume” is associated with a business concept of quantity, and in particular of quantity of stocks. On the other hand, if semantic model constructor 22 discovers contextual clues related to cargo delivery, semantic model constructor 22 may then determine that the data item heading “volume” is associated with a business concept of a three-dimensional physical volume capacity, and in particular of a three-dimensional physical volume of cargo capacity.

Data item headings may be horizontally proximate to a particular data item heading of interest if they are additional data item headings of the same form of the particular data item heading and part of the same file, directory, or other environment as the particular data item heading. For example, if the particular data item heading of interest is a column heading in a spreadsheet, the other column headings in the spreadsheet may be considered horizontally proximate to the particular data item heading. Data item headings may be vertically proximate to a particular data item heading of interest if they are hierarchically separated from the particular data item heading within an organizational hierarchy of file portions, file, directory, etc., such that one is included as part of the other.

For example, if the particular data item heading of interest is a column heading in a spreadsheet, then vertically separated data item headings relative to that column heading may include the sheet name of the sheet in which the column appears, the internally written title of the sheet, the file name of the spreadsheet file, or the directory name of a directory that contains the spreadsheet file, for example. In a particular example related to a column heading of interest named “volume” as in the example described above, semantic model constructor 22 may evaluate horizontally and/or vertically proximate data item headings and discover that the sheet name and the file name of the sheet and file that contain the column both include content that makes reference to stock market trades. Semantic model constructor 22 may take these clues in the vertically proximate data item headings to be contextual clues to the conceptual nature of the column heading of interest, in this example.

In one example, semantic model constructor 22 may include or access a single hierarchy of concepts organized as a business ontology 64, and a series of language-specific detection rules 62 (e.g., rules for identifying lexical clues) that may be used commonly in each of several languages to signify business concepts and model data in a mapping with relationships and patterns defined in the business ontology. As simple examples of concepts, the concept “caption” may be listed as a top-level or generic concept. A top-level concept may be intended to apply to a broad, generic concept that may have a broad range of more specific types. For example, the concept “caption” may incorporate a wide range of types of names, labels, and other identifiers. The concept “caption” may include, or be extended by, one or more special cases of concepts that may be considered narrower or second-level concepts within the broader, top-level concept of “caption.” As a particular example, the concept “caption” may be extended by the concept “first name” as a special case of the “caption” concept.

In one implementation, each concept may be encoded as an attribute with a name that begins with a lower case “c” (for concept) followed by a string (e.g., in camel case) based on one or more English words (in this example) for the concept, e.g., “cCaption” for the “caption” concept, “cFirstName” for the “first name” special case concept within the “caption” concept, and so forth, as in the following two examples:

```
      <attribute name=“cCaption”>
            <dataHints>
                  <pattern>String</pattern>
            </dataHints>
      </attribute>
and:
      <attribute name=“cFirstName”>
            <extends>cCaption</extends>
      </attribute>
```

To recognize and identify these concepts in a collection of data, concept identifier tool 22 may identify clues such as lexical clues in column headings, for example. Concept identifier tool 22 may use any of various language processing or analysis tools, such as tokenizing content, analyzing word stems and near matches, and otherwise evaluating lexical clues specific to each of one or more particular natural languages.

Semantic model constructor 22 may use the resulting set of clues from tokenizing and analyzing data item heading tokens to match concept keywords with the data item headings. Semantic model constructor 22 may look up concept keywords associated with one or more concepts in a business ontology, that represents or is based on a business ontology, as potential candidates to explain the data item heading.

Semantic model constructor 22 may further validate likely candidate concepts as matches with data item headings using other clues, such as data patterns, the actual values of data listed under the data item heading, surrounding context of the data, and other factors. For example, when looking up candidate concepts for a given set of clues or potential matches, semantic model constructor 22 may assign priority to concepts that are signified by a greater number of matches between their concept keywords and the data item heading. For example, given a data item heading or title such as “AIRPORTNAME,” semantic model constructor 22 may initially identify the concept “caption” as a potential match with the data item heading, based on a match with the concept keyword of “name” associated with the concept “caption,” pending further validation. However, during the validating process, semantic model constructor 22 may identify a separate concept, “AirportName,” in the applicable business ontology, that has concept keywords of “airport” and “name” that match the combination of two clues or data item heading tokens, “airport” and “name,” from the data item heading.

Some business ontologies may not have a general concept of “AirportName” separate from the concept of “caption,” but this may be different in the case of a particular business ontology tailored to a particular business ontology of a particular business in which airport names are of special significance. In this case, since concept identifier tool 22 identifies multiple concept keywords of a single concept in the business ontology that match multiple data item heading tokens of the data item heading, concept identifier tool 22 may select the concept “AirportName” instead of the concept “caption” as its final selection to identify a particular concept with the data item heading.

Identifying the one or more matches between the data item heading and the one or more concept keywords associated with the particular concept may therefore include validating the one or more matches between the data item heading and the one or more concept keywords associated with the particular concept against additional evidence from the data source. In one example, the data item heading is a first data item heading, and the additional evidence from the data source may include one or more of: values of data associated with the first data item heading, patterns of data associated with the first data item heading, and additional data item headings comparable to the first data item heading.

Once semantic model constructor 22 makes its final identification of a concept with a data item heading, semantic model constructor 22 may apply a concept tag in association with the data item heading. The concept tag may indicate the particular concept with which the data item heading is identified as being associated. Semantic model constructor 22 may output the concept tag in association with the data item heading to other systems, such as part of the output of a BI system to a consuming application such as a BI dashboard or other BI user interface. In some examples, semantic model constructor 22 may use the identification of the concept with the data item heading to identify a business intelligence portal output mode that corresponds to the particular concept and output the business intelligence portal output mode identified as corresponding to the particular concept. For example, semantic model constructor 22 may identify a time-ordered graph displaying a data visualization of the data under the data item heading as it varies over time, as a business intelligence portal output mode that corresponds to the particular concept of “time” that is identified as associated with the data item heading. In other examples, a consuming application, such as a BI dashboard, may use concept tags or other information it receives from semantic model constructor 22 to determine such an appropriate business intelligence portal output mode identified as corresponding to the particular concept.

Therefore, in an example in which the particular concept is identified as being or including time, the business intelligence portal output mode identified by concept identifier tool 22 as corresponding to the particular concept may include a data visualization of one or more variables in relation to time. In another example, the particular concept is identified as being or including a name or names, and the business intelligence portal output mode identified by concept identifier tool 22 as corresponding to the particular concept may include a data visualization of one or more variables in relation to entries corresponding to the names. The variables may be any type of data found in a data source, and may include time-ordered sets of data that vary relative to categories such as time, geography, business division, product line, and so forth. Examples of such variables may include sales, revenue, profits, margins, expenses, customer or user count, stock trading volume, stock share price, interest rates, or any other value of interest.

Semantic model constructor 22 may generate and output a semantic model in various forms resulting from its analyses of a data set. In one example, semantic model constructor 22 may output a graph that represents its best interpretation of a data set or a subset of a data set. This graph may represent how certain data elements are grouped together to represent a single entity (for example product_code and product_name may be different characteristics of product) and also how entities are related to one another (for example, a Product Line may include many Products).

An example process that semantic model constructor 22 performs may include extracting lexical clues from a data set or data source; determining a set of candidate concepts from a business ontology, based at least in part on the lexical clues; using the business ontology as a network of concepts; and employing techniques (e.g., an activation spreading paradigm) to establish an interpretation context based on the candidate concepts. Semantic model constructor 22 may further use such an interpretation context along with data hints and data samples to disambiguate from among competing or potential candidate concepts, and set expectations for resolving data items for which lexical clues were not sufficient to identify applicable concepts with high confidence. Semantic model constructor 22 may then use the disambiguated concepts and consult the business ontology in generating a semantic model that may include organizing the input data items into categories (e.g., including one or more data items) and metrics. Semantic model constructor 22 may also generate or suggest whole-part navigation paths among the data item headings, categories, or other semantic information.

Data set 1 below shows an example data set that contains information about cargo landed in various airports:

Data set 1

| | | | | | | | | | J |
|---|---|---|---|---|---|---|---|---|---|
| | | | | | | | | | 2010 |
| | | | | | | | H | | Landed |
| A | B | C | D | E | F | G | Svc | I | weight |
| Rank | RO | ADO | ST | LOCID | Airport Name | City | Lvl | Hub | (lbs.) |
| 1 | SO | MEM | TN | MEM | Memphis International | Memphis | P | M | 19,554,639 |
| 2 | AL | AAL | AK | ANC | Ted Stevens | Anchorage | P | M | 19,463,543 |
| | | | | | International | | | | |
| 3 | SO | MEM | KY | SDF | Louisville | Louisville | P | S | 10,637,706 |
| | | | | | International- | | | | |
| | | | | | Standiford Field | | | | |
| 4 | SO | ORL | FL | MIA | Miami International | Miami | P | L | 6,905,297 |
| 5 | GL | CHI | IL | ORD | Chicago O'Hare | Chicago | P | L | 4,895,946 |
| | | | | | International | | | | |
| 6 | GL | CHI | IN | IND | Indianapolis | Indianapolis | P | M | 4,717,483 |
| | | | | | International | | | | |
| 7 | WP | LAX | CA | LAX | Los Angeles | Los | P | L | 3,954,810 |
| | | | | | International | Angeles | | | |
| 8 | EA | NYC | NY | JFK | John F. Kennedy | New York | P | L | 3,899,848 |
| | | | | | International | | | | |
| 9 | SW | TEX | TX | DFW | Dallas/Fort Worth | Fort Worth | P | L | 3,031,597 |
| | | | | | International | | | | |
| 10 | EA | NYC | NJ | EWR | Newark Liberty | Newark | P | L | 2,979,318 |
| | | | | | International | | | | |

FIG. 4 depicts an example semantic business intelligence (BI) model 66N that semantic model constructor 22 may generate for this data set. Semantic BI model 66N is illustratively depicted with various types of blocks representing various types of information, and with various organizational relations depicted among the blocks. Each of the blocks is labeled with a label beginning with a lower case letter “c” to indicate a concept in the business ontology, to which the information associated with the block conforms, with the letter “c” followed by a label indicating, in an unbroken camel case string in this example, the particular type of information represented by that concept.

In particular, in semantic BI model 66N, metric blocks 202, 204, and 206 represent metrics; category blocks 212, 214, 216, 218, 220, 222, 224, and 226 represent categories which are groupings of data item headers (e.g., Airport Name, LocID (location ID)); and data item header blocks 232, 234, 236, 238, 240, 242, 244, 246 and 248 represent data item headers that may be identifiers in general, or specific types of identifiers such as captions, for example. Semantic BI model 66N also contains whole-part associations, represented by thick black arrow connectors 252 and 254, between categories that semantic model constructor 22 finds to have whole-part associations between them. Semantic BI model 66N may also indicate relationships between blocks such as between identifiers and captions or names associated with the identifiers. As an example, cCategory block 218 (for a “category” concept) is indicated to have associations with both cIdentifier block 240, in which a LocID data item heading is mapped to “cIdentifier” or identifier concept, and with cCaption block 238 (for a “caption” concept) in which an Airport Name data item heading is mapped to “cCaption” or a caption concept.

For example, semantic model constructor 22 may identify that a State may have a whole-part association with a City that is a part of that State, as represented in organize semantic BI model 66N by whole-part association connector 254 between “cStateProvince” category block 220, representing the geographical concept of a state or province in business ontology 64, and “cCity” category block 222, representing the geographical concept of a city in business ontology 64. Thus, each category block may have an associated concept from business ontology 64 associated with the category block, such that semantic model constructor 22 maps the information in the category block to the business ontology concept from business ontology 64. For example, the category associated with data item heading “ST” is interpreted to be a state (e.g., in the U.S.A. or Germany), province (e.g., in Canada or France), prefecture (e.g., in Japan), or other top-level internal division of a country, categorized as one equivalent concept, named concept “cStateProvince” and with category block 220 mapped to this concept in this example.

As also shown in FIG. 4, semantic BI model 66N may include whole-part navigation paths between different information blocks representing associations between the information represented therewith. Some illustrative examples of whole-part navigation paths in semantic BI model 66N include the arrow path between cCategory category block 214 and cIdentifier ADO data item header block 234, and the arrow path between cNominal category block 212 and cIdentifier ADO data item header block 232. Semantic model constructor 22 may generate or suggest the whole-part navigation paths based on lexical clues and relationships among the underlying data, such as data item headings that are proximate to a data item of interest, for example. Semantic model constructor 22 may lack independent information about the nature of the underlying data item headers “ADO” and “RO” in the data source, but may correlate data values for these two items, and thereby establish a whole-part association between these data items as indicated in semantic BI model 66N.

FIG. 5 shows a flowchart for an example overall process 70 that semantic model constructor 22, executing on one or more computing devices (e.g., servers, computers, processors, etc.), may perform. Semantic model constructor 22 may identify one or more lexical clues associated with each of one or more data item headings from the data source based on a set of lexical clue detection rules (72). Semantic model constructor 22 may map each of one or more of the data item headings to one or more of the business concepts based on comparing the one or more identified lexical clues associated with each of one or more of the data item headings with a business ontology that comprises a description of the business concepts (74). Semantic model constructor 22 may generate a semantic business intelligence model comprising one or more semantic associations between the data headings based on the mapping of the data item heading to the one or more of the business concepts (76). Semantic model constructor 22 may perform additional functions such as those described in the examples and description above.

FIG. 6 is a block diagram of a computing device 80 that may be used to execute a semantic model constructor 22, according to an illustrative example. Computing device 80 may be a server such as one of web servers 14A or application servers 14B as depicted in FIG. 2. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind Other implementations of a computing device 80 may include a computer having capabilities or formats other than or beyond those described herein.

In the illustrative example of FIG. 6, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Some examples may use such a non-transitory medium. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a semantic model constructor 22, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

As will be appreciated by a person skilled in the art, aspects of the present disclosure may be embodied as a method, a device, a system, or a computer program product, for example. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible data storage medium (which may be non-transitory in some examples), as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wire line, optical fiber cable, etc., or any suitable combination of the foregoing. Computer program code for carrying out operations for aspects of the present invention may be written in any combination of one or more programming languages, including an object oriented programming language such as Java, Smalltalk, C++, or the like, or other imperative programming languages such as C, or functional languages such as Common Lisp, Haskell, or Clojure, or multi-paradigm languages such as C#, Python, or Ruby, among a variety of illustrative examples. One or more sets of applicable program code may execute partly or entirely on the user's desktop or laptop computer, smartphone, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures. A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present invention are described herein with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer-implemented process such that the instructions that execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may be executed in a different order, or the functions in different blocks may be processed in different but parallel processing threads, depending upon the functionality involved. Each block of the block diagrams and/or flowchart illustration, and combinations of blocks in the block diagrams and/or flowchart illustration, may be implemented by special purpose hardware-based systems that perform the specified functions or acts, or combinations of executable instructions, special purpose hardware, and general-purpose processing hardware.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

What is claimed is:

1. A method for constructing a semantic model of a data source, the method comprising:
identifying, with one or more computing devices, one or more lexical clues associated with each of one or more data item headings from the data source based on a set of lexical clue detection rules;
mapping, with the one or more computing devices, each of one or more of the data item headings to one or more business concepts based on comparing the one or more identified lexical clues associated with each of one or more of the data item headings with a business ontology that comprises a description of the business concepts; and
generating, with the one or more computing devices, a semantic business intelligence model comprising one or more semantic associations between the one or more data item headings based on the mapping of the data item headings to the one or more of the business concepts.

2. The method of claim 1, further comprising classifying the one or more data item headings as either a metric or a category based on the comparing of the one or more identified lexical clues with the business ontology.

3. The method of claim 1, wherein mapping, each of the one or more of the data item headings to the one or more of the business concepts further comprises:
identifying a particular concept from among multiple candidate concepts based on evidence from the one or more identified lexical clues.

4. The method of claim 1, wherein mapping, each of the one or more of the data item headings to the one or more of the business concepts further comprises:
identifying one or more of the data item headings for which the one or more identified lexical clues are insufficient for mapping to one of the business concepts.

5. The method of claim 1, wherein the business concepts comprise one or more category concepts and one or more metric concepts, and wherein generating the semantic business intelligence model further comprises:
identifying each of one or more of the data item headings as either one of the category concepts or one of the metric concepts.

6. The method of claim 5, wherein identifying each of one or more of the data item headings as either one of the category concepts or one of the metric concepts further comprises:
identifying each of one or more of the data item headings as a particular type of category.

7. The method of claim 5, wherein identifying each of one or more of the data item headings as either one of the category concepts or one of the metric concepts further comprises:
identifying each of two or more of the data item headings as being comprised in a single category.

8. The method of claim 5, wherein identifying each of one or more of the data item headings as either one of the category concepts or one of the metric concepts further comprises:
generating one or more whole-part navigation paths between two or more of the data item headings identified as a category concept.

9. The method of claim 1, further comprising validating the mapping of one or more of the data item headings to one or more of the business concepts based on one or more of data, metadata, and additional data item headings proximate to the one or more of the data item headings in the data source.

10. The method of claim 9, wherein validating the mapping of one or more of the data item headings to one or more of the business concepts further comprises:
validating one or more matches between one or more of the data item headings and one or more concept keywords associated with the one or more of the business concepts against additional evidence from the data source.

11. The method of claim 1, further comprising:
providing the semantic business intelligence model to a business intelligence portal.

12. The method of claim 1, further comprising:
identifying a business intelligence portal output mode that corresponds to the semantic business intelligence model; and
outputting the business intelligence portal output mode identified as corresponding to the semantic business intelligence model.

13. The method of claim 12, wherein the semantic business intelligence model indicates variation of values of one or more data items in relation to time, and the business intelligence portal output mode identified as corresponding to the semantic business intelligence model comprises a data visualization of the variation of the values of the one or more data items in relation to time.

14. The method of claim 12, wherein the semantic business intelligence model indicates variation of values of one or more data items in relation to identifiers, and the business intelligence portal output mode identified as corresponding to the semantic business intelligence model comprises a data visualization of the variation of the values of the one or more data items in relation to the identifiers.

15. The method of claim 1, wherein the data item heading comprises one or more of a column heading, a row heading, a sheet name, a graph caption, a file name, and a document title from the data source.

16. A computer system for constructing a semantic model of a data set, the computer system comprising:
one or more processors, one or more computer-readable memories, and one or more computer-readable, tangible storage devices;
program instructions, stored on at least one of the one or more storage devices for execution by at least one of the one or more processors via at least one of the one or more memories, to identify one or more lexical clues associated with each of one or more data item headings from the data source based on a set of lexical clue detection rules;
program instructions, stored on at least one of the one or more storage devices for execution by at least one of the one or more processors via at least one of the one or more memories, to map each of one or more of the data item headings to one or more business concepts based on comparing the one or more identified lexical clues associated with each of one or more of the data item headings with a business ontology that comprises a description of the business concepts; and
program instructions, stored on at least one of the one or more storage devices for execution by at least one of the one or more processors via at least one of the one or more memories, to generate a semantic business intelligence model comprising one or more semantic associations between the one or more data item headings based on the mapping of the data item headings to the one or more of the business concepts.

17. The computer system of claim 16, wherein the program instructions to map each of one or more of the data item headings to one or more of the business concepts further comprise:
program instructions, stored on at least one of the one or more storage devices for execution by at least one of the one or more processors via at least one of the one or more memories, to identify a particular concept from among multiple candidate concepts based on evidence from the one or more identified lexical clues.

18. The computer system of claim 16, wherein the program instructions to map each of one or more of the data item headings to one or more of the business concepts further comprise:
program instructions, stored on at least one of the one or more storage devices for execution by at least one of the one or more processors via at least one of the one or more memories, to identify one or more of the data item headings for which the one or more identified lexical clues are insufficient for mapping to one of the business concepts.

19. The computer system of claim 16, wherein the business concepts comprise one or more category concepts and one or more metric concepts, and wherein the program instructions to generate a semantic business intelligence model further comprise:
program instructions, stored on at least one of the one or more storage devices for execution by at least one of the one or more processors via at least one of the one or more memories, to identify each of one or more of the data item headings as either one of the category concepts or one of the metric concepts.

20. A computer program product for constructing a semantic model of a data set, the computer program product comprising a computer-readable storage medium having program code embodied therewith, the program code executable by a computing device to:
identify one or more lexical clues associated with each of one or more data item headings from the data source based on a set of lexical clue detection rules;
map each of one or more of the data item headings to one or more business concepts based on comparing the one or more identified lexical clues associated with each of one or more of the data item headings with a business ontology that comprises a description of the business concepts; and
generate a semantic business intelligence model comprising one or more semantic associations between the one or more data item headings based on the mapping of the data item headings to the one or more of the business concepts.
